(19) United States
(12) Patent Application Publication
(10) Pub. No.: US 2014/0255872 A1
(43) Pub. Date: Sep. 11, 2014

(54) DENTAL IMPLANT WITH ANGLED HEAD AND BENDING ZONE

(71) Applicant: Biomed Est., Liechtenstein (DE)

(72) Inventor: Stefan Ihde, Vrba/Tudorovici (ME)

(73) Assignee: Biomed Est., Liechtenstein (DE)

(21) Appl. No.: 14/102,552

(22) Filed: Dec. 11, 2013

(30) Foreign Application Priority Data
Mar. 11, 2013 (DE) 20 2013 002 300.7

(51) Int. Cl. A61C 8/00

(52) U.S. Cl. CPC A61C 8/0028
USPC 433/174; 433/173

(57) ABSTRACT

A dental implant includes an enossal implant body, a head, and a neck or bending zone and a prosthetic platform or an abutment equator, and at least one rotation securing engagement surface or parts thereof that come to rest underneath the prosthetic platform or the abutment equator. The implant head may be mounted at an angle to a longitudinal axis of the enossal implant body.

### CROSS REFERENCE

This application claims priority to German Patent Application No. 20 2013 002 300.7, filed Mar. 11, 2013.

### TECHNICAL FIELD OF THE INVENTION

The invention relates to a dental implant.

### BACKGROUND OF THE INVENTION

Dental implants are ordinarily anchored in the bone. They transfer the masticatory force from the mouth to the bones and to this end they have a transmucosal zone which negotiates the distance between the abutment in the mouth space and the bone. In the past, multiple part and single part implants have been used. This means that the implant body in the bone is produced separately from or in one piece with the abutment head. In addition, implants are known that permit a screw connection with the bridge, or such which facilitate a cementing or adherence. If bridge and abutment head are screwed, the bridge can be easily unscrewed and e.g. repaired.

The often unfavorable bone conditions in the mouth cause problems for the implantologists and prosthodonists: the bone often lies in unfavorable places and/or in unfavorable formation, and therefore the implant bodies are often not installed parallel to one another in the jaw. To solve this problem, on the one hand angled abutments were developed (i.e. the abutments are screwed right on the implant, but they have a bend). On the other hand, one-piece implants have been specified which have a bendable neck, and which permit a parallelization of the abutment heads by bending the neck. In practice there are risks associated with these turns, in particular with the fracture of the implant neck during the screwing in or turning, and in addition with undesirable fractures of the bone. Since, in the event of bending the metal structure of the implant body in the neck (=bend) region changes, bends of the implant neck as mentioned are only possible up to circa 15 degrees. If one bends the implant neck more, the risk of material fatigue exists. It is ideal if, independent from the morphology of the implant body overall, i.e. for all partial regions of the implant (1, 2, 3, 4, 5) an identical or almost identical metal structure is present, and in particular in the thinner neck region (5) no higher hardness of the material is given.

Through too strong and in particular by multiple bending of the implant neck (5) the material present there obtains a greater hardness and the brittleness increases. Already during the bending some implants can immediately snap off, others do not fail until after years of variable loads during the chewing function.

The invention addresses the problem of developing an implant that can compensate the greatest possible angular differences without the head breaking due to its morphology or changes in the metal structure during utilization or during the screwing in of the implant.

### SUMMARY OF THE INVENTION

This problem is solved in accordance with the invention by producing the implant in one piece and by the head (3) having a bend of e.g. 10 to 25 degrees vis-à-vis the longitudinal axis of the implant body (A1). It is important for the function of the invention that this bend is not generated by the bending after the turning of the implant body, but rather that the implant is produced with this head angle on the machines directly. As a result the metal structure of the implant body is unchanged vis-à-vis the raw material. Changes in acceptable scope do not arise until the implantologist additionally changes the angle between the head and the implant axis after installation of the implant, e.g. adjusts it by bending.

With this simple solution, it is possible to compensate angular differences of a greater scope, because the angle provided at the factory of, for example 10 to 25 degrees after the insertion of the implant by bending producible additional bending of a further circa 15 degrees is added. I.e. in the event of an angulation of the head of the implant of 15% degrees the head of the implant can be bent straight against the longitudinal axis (A1) without risk for the metal structure to 0 degrees, or it can—likewise without risk—be bent a total of 30 degrees. When one considers that the head thus bent can still be oriented in different directions by screwing in or unscrewing (e.g. 180 degrees), then 2×30 degrees deviation from the implant main axis are possible, which in practice is more than sufficient to favorably position the implant head and easily fit a prosthetic.

One great difficulty for the insertion of such pre-angulated implants is the insertion into the bone. To be able to work with mechanical installation aids it is absolutely necessary to place the installation aid precisely in axial direction (A1) on the implant. In addition, engagement surfaces or slots must be provided in the region of the implant head (3), said engagement surfaces or slots allowing the transfer of screwing forces. Since the implant head must be designed as delicately as possible for improvement of the aesthetics, in the event of angulated implants the mounting of the necessary surface causes difficulties, since, at least on one side of the head the surfaces are too small.

In accordance with the invention the aforementioned problems in the installation of the described pre-angulated implant are solved by mounting the surfaces (6, 7) parallel to the implant main axis (A1) at least partially under the prosthetic platform (8) or the greatest diameter (8a) of the implant head (3), while the opposite surface or further surfaces are mounted above the prosthetic platform (8) or the greatest diameter of the implant head (8a). The proper function of this invention requires that at least two surfaces (6, 7) must be mounted, more surfaces are technically possible and occasionally helpful. These surfaces (6, 7) cooperate with corresponding surfaces of the insertion aid (10) of the implant.

In a particularly advantageous embodiment of the invention the implants are delivered pre-mounted together with the installation aids.

For the inventive implant the installation aid also serves as a bending instrument, alone or in cooperation with a structure extending the lever (e.g. ratchet, extension).

Astonishingly, the inventive solution deviates from the previous state of the art: solutions are known in which the surfaces or shapes which the safeguard against rotation makes possible between implant and installation aid, are either accommodated in the implant head (e.g. “internal hexagon”, “internal octagon”, “internal trilobe”, etc.) or these structures are located outside of the head (e.g. as outer hexagon).

It is not important for the function of the invention whether the head structure (4) is constructed for the later cementing of the prosthetic workpiece or for screwing via a thread (4). Also, the combination of screwing and cementing, in which case a screw connection is provided via the thread (4) as well as a cementing to the outer cone (9), is an advantageous technical solution in some cases.

In place of surfaces (6,7) raised slots or embedded longitudinal grooves can be mounted in the implant head (3), wherein these grooves or slots then cooperate with corresponding grooves and/or slots in the installation aid.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a dental implant according to an embodiment of the present invention.

FIG. 2 shows an abutment head for a dental implant according to another embodiment from above.

FIG. 3 shows a dental implant according to another embodiment.

FIG. 4 shows an assembly of an abutment head according to an embodiment.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

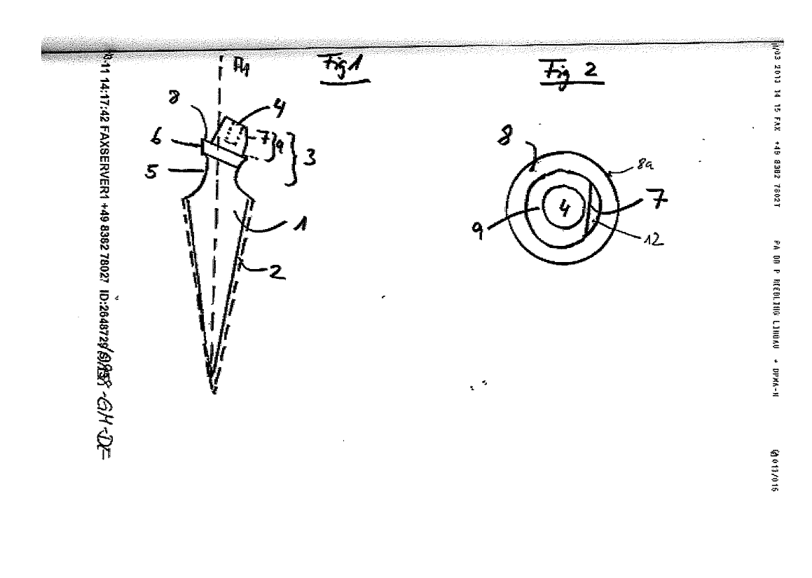

FIG. 1 shows an inventive dental implant with the enossal implant body (1) and thread region (2) as well as head (3). An engagement surface (6) parallel to the implant main axis (A1) lies below the abutment equator (8a) or the prosthetic platform (8), while the opposite surface (7) lies above the abutment equator.

An inner screw connection (4) on the head structure (9) facilitates the assembly of a screwed prosthetic workpiece. A thin neck region (transmucosal region) lies between the implant head (3) and the implant body in which the head (3) of the implant is angled vis-à-vis the implant body (1) and can be bent additionally after the installation.

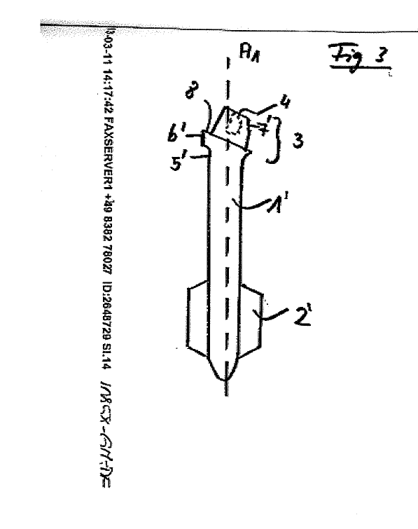

FIG. 2 shows the abutment head (3) from above, with the prosthetic platform (8), the greatest circumference (8a) and the engagement-surface (7). An additional detent is represented by (12), upon which the installation aid can support itself.

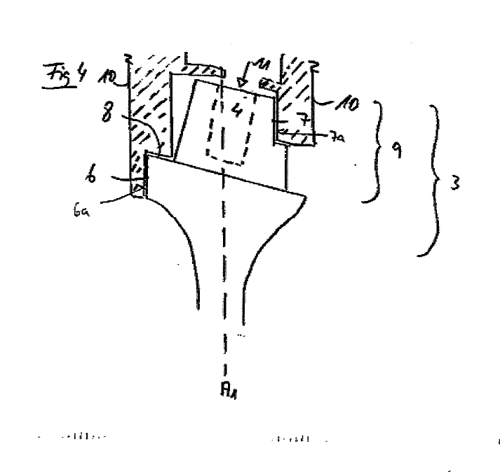

FIG. 3 shows an inventive dental implant with the enossal implant body (1′) and wide thread region (2′) in the proximity of the implant tip as well as head (3). An engagement surface (6′) parallel to the implant main axis (A1) lies beneath the abutment equator (8a) or the prosthetic platform (8), while the opposing surface (7′) lies above the abutment equator.

An inner screw connection (4) on the head structure (9) facilitates the assembly of a screwed prosthetic workpiece. In place of a narrow area in the region of the neck tapered for the bending in the mouth, the neck of the implant tapers below the head (3) without the provision of a special bending zone.

FIG. 4 shows an assembly of the inventive abutment head (3) with the installation aid (10). Above the inner thread (4) a hole (11) lies in the installation help (10), said hole through which the two workpieces (3, 10) can be screwed to one another with the help of a screw (not shown here).

The installation aid (10) has corresponding surfaces (6a, 7a) that cooperate with the axis parallel surfaces of the implant (6, 7), in the process providing a safeguard against rotation between implant and installation aid and thus facilitate screwing in the implant into the bone.

In an especially advantageous embodiment of the inventive implant conical compression thread areas (2) and wide apical thread areas (2′) are combined with one another, with which simultaneously the apical thread (2′) can cut into the counter cortical substance of the bone, and the compression thread holds well in the compressible songiosa structure of the bone.

The inventive implant can be offered and used in combination with compression screws (2, FIG. 1) and apical cutting screws (2′, FIG. 3) in an implant set, which gives the dentist the choice of using either the bone compression of the soft bone for the anchoring, or the cortical support, i.e. the apical cutting thread.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

### LIST OF REFERENCES

A1 Implant main axis
1, 1′ Implant body
2, 2′ Thread region of the implant body
3 Implant head
4 Thread region
5, 5′, 5′ Neck, or transmucosal zone of the implant
6, 6′, 7 Engagement surfaces on the implant, parallel to the implant main axis Al
6a, 7a Corresponding engagement surfaces on the installation aid
8 Prosthetic platform
8a Greatest diameter of the implant head
9 Head structure above the prosthetic platform or above the head equator
10 Installation aid
11 Opening for the screwing of the installation aid and implant head
12 Detent or layer below the engagement surface (7)

1. A dental implant, comprising:
an enossal implant body,
a head, and
a neck or bending zone and a prosthetic platform or an abutment equator, and
at least one rotation securing engagement surface or parts thereof that come to rest underneath the prosthetic platform or the abutment equator.

2. The dental implant according to claim 1, further comprising at least one further engagement surface for the cooperation of the implant head with an installation aid comes to rest above the prosthetic platform or the abutment equator.

3. The dental implant according to claim 1, wherein the implant head is mounted at an angle to a longitudinal axis of the enossal implant body.

4. The dental implant according to claim 1, further comprising a screw connection in the head for connection of a prosthetic workpiece.

5. The dental implant according to claim 1, wherein a connection to a prosthetic workpiece is realized in one of at least one further engagement surface or a cone by means of cementing.

6. The dental implant according to claim 1, wherein the enossal implant body further comprises conical thread areas or wider, primarily cutting thread areas on a tip of the enossal implant body.

7. The dental implant according to claim 1, further comprising longitudinal grooves or longitudinal slots in the region of the head, wherein at least one of these longitudinal grooves or slots comes to rest underneath the prosthetic platform or the abutment equator.

8. The dental implant according to claim 1, wherein the implant body and head have an identical or almost identical metal structure.

9. The dental implant according to any claim 1, wherein said enossal implant body further comprises compression thread areas and apically cutting thread areas in an implant set.

10. The dental implant according to claim 8, wherein a neck region between the enossal implant body and the head has a material hardness that is no higher than that of the implant body and the head.
